(19) United States
(12) Patent Application Publication
(10) Pub. No.: US 2016/0183290 A1
(43) Pub. Date: Jun. 23, 2016

(54) UPLINK SCHEDULING METHOD AND UPLINK TRANSMISSION METHOD

(71) Applicant: ELECTRONICS AND TELECOMMUNICATIONS RESEARCH INSTITUTE, Daejeon (KR)

(72) Inventors: Young Jo KO, Daejeon (KR); Sung-Hyun MOON, Daejeon (KR); Cheulsoon KIM, Daejeon (KR); Joonwoo SHIN, Daejeon (KR); Jae Young AHN, Daejeon (KR)

(21) Appl. No.: 14/909,415

(22) PCT Filed: Jul. 31, 2014
(86) PCT No.: PCT/KR2014/007029

§ 371 Date: Feb. 1, 2016

(30) Foreign Application Priority Data
Aug. 2, 2013 (KR) 10-2013-0091919
Jul. 31, 2014 (KR) 10-2014-0097929

(51) Int. Cl. H04W 72/12; H04L 1/18; H04L 5/00; H04W 72/04; H04W 52/36

(52) U.S. Cl. CPC H04W 72/1284; H04W 72/0413; H04W 72/0473; H04W 52/365; H04L 5/0055; H04L 1/1812; H04W 72/0446; H04W 88/02

(57) ABSTRACT

In a wireless communication system which supports dual connection between a terminal and at least two base stations, a terminal provides an uplink transmission method based on uplink scheduling information, and a base station provides an uplink scheduling method for sharing information on a type of subframe and allocating an uplink resource.

### TECHNICAL FIELD

The present invention relates to an uplink transmission method of a terminal for supporting dual connectivity and an uplink scheduling method of a base station.

### BACKGROUND ART

In dual connectivity, connections between a terminal and two base stations are simultaneously maintained.

For example, when considering a situation in which one terminal is connected to both a macrocell and a small cell, the macrocell may manage mobility of the terminal and provide cellular coverage and the small cell may be mainly responsible for transmission/reception of data to/from the terminal. In this case, the macrocell mainly serves as a control plane, and therefore may control and manage communication between the terminal and the base station. Therefore, the macrocell needs to have higher priority allocated to communication with the terminal, compared to the small cell mainly serving as a user plane. On the other hand, relatively fewer resources may be used in communication between the macrocell and the terminal to which control information is mainly transmitted than in communication between the small cell and the terminal to which data is mainly transmitted.

However, when the two base stations simultaneously connected to the terminal are connected to each other through a non-ideal backhaul, it is difficult to immediately provide information exchange between the base stations and support the dual connectivity.

### DISCLOSURE

### Technical Problem

The present invention has been made in an effort to provide an uplink scheduling method of two base stations connected to each other through a non-ideal backhaul, and an uplink transmission method of a terminal to the base stations dual-connected to the terminal.

### Technical Solution

An exemplary embodiment of the present invention provides an uplink transmission method of a terminal in a wireless communication system supporting dual connection between a terminal and at least two base stations. The uplink transmission method includes: receiving first uplink scheduling information and type information of a subframe of a first base station from the first base station of the at least two base stations; receiving second uplink scheduling information of a second base station from the second base station of the at least two base stations; and transmitting uplink signals or channels to the first base station and the second base station, respectively, based on the first uplink scheduling information, the second uplink scheduling information, and the type information of the subframe.

The type information of the subframe may include at least three types of subframe.

A first subframe of a first type of the at least three types may be a shared subframe of the first base station and the second base station.

The transmitting may include simultaneously transmitting the uplink signals or the channels to the first base station and the second base station in a first subframe of a first type of the at least three types.

The transmitting may include: preferentially allocating power to a transmission to the first base station when the first base station is a master eNB and the second base station is a secondary eNB; and allocating power headroom after being allocated to the transmission to the first base station to a transmission to the second base station.

The transmitting may include: preferentially allocating power to the transmission of the control channel when the channel transmitted to the first base station is a control channel and the channel transmitted to the second base stations is a shared channel; and allocating power headroom after being allocated to the transmission of the control channel to the transmission of the shared channel.

The first subframe of the first type of the at least three types may be a dedicated subframe of the first base station, and a second subframe of a second type of the at least three types may be a dedicated subframe of the second base station.

The transmitting may further include: transmitting the uplink signal or the channel to the first base station in the first subframe of the first type of the at least three types; and transmitting the uplink signal or the channel to the second base station in the second subframe of the second type of the at least three types.

The uplink transmission method may further include: transmitting maximum transmission power and power headroom (PHR) for a serving cell managed by the first base station; and transmitting maximum transmission power, PHR, and type information of the PHR for a serving cell managed by the second base station to the first base station.

The uplink transmission method may further include: transmitting maximum transmission power and power headroom (PHR) for a serving cell managed by the second base station; and transmitting maximum transmission power, PHR, and type information of the PHR for a serving cell managed by the first base station to the second base station.

Another exemplary embodiment of the present invention provides an uplink scheduling method of a base station in a wireless communication system supporting dual connection between a terminal and at least two base stations. The uplink scheduling method includes: allocating a semi-static resource to a first subframe; transmitting information on the first subframe to a first base station of at least two base stations; and transmitting uplink scheduling information including the information on the first subframe to the terminal.

The semi-static resource may include an SPS scheduling resource, a periodic channel state information (CSI) reporting resource, a trigger-type 0 resource, and a scheduling request (SR) resource.

The uplink scheduling method may further include: allocating a dynamic allocation resource to a second subframe; transmitting information on the second subframe to the remaining one base station; and transmitting uplink scheduling information including the information on the second subframe to the terminal.

The dynamic allocation resource may include a resource for an uplink HARQ-ACK or a trigger-type 1 sounding reference signal (SRS) transmitted as a response to PDCCH/e-PDCCH.

The determining of the second subframe for the dynamic allocation resource may include determining the second subframe in consideration of an uplink HARQ process.

Yet another exemplary embodiment of the present invention provides an uplink scheduling method of a base station in a wireless communication system supporting dual connection between a terminal and at least two base stations. The uplink scheduling method includes: dividing a type of subframe into at least three types; allocating an uplink resource to a first subframe of a first type of the at least three types; and transmitting uplink scheduling information including information on the first subframe to the terminal.

The uplink scheduling method may further include transmitting information on the type of subframe to a first base station of the at least two base stations.

The first subframe may be a dedicated subframe of the base station, a second subframe of a second type of the at least three types may be a dedicated subframe of the first base station, and a third subframe of a third type of the at least three types may be a shared subframe of the base station and the first base station.

Still another exemplary embodiment of the present invention provides an uplink scheduling method of a base station in a wireless communication system supporting dual connection between a terminal and at least two base stations. The uplink scheduling method includes: receiving information on a first subframe to which an uplink resource of a first base station is allocated from the first base station of the at least two base stations; allocating the uplink resource of the base station to the first subframe and another second subframe based on the information on the first subframe; and transmitting uplink scheduling information including information on the second subframe to the terminal.

The uplink scheduling method may further include receiving information on a subframe divided into at least three types from the first base station.

The first subframe of the first type of the at least three types may be a dedicated subframe of the first base station, the second subframe of the second type of the at least three types may be a dedicated subframe of the base station, and a third subframe of a third type of the at least three types may be a shared subframe of the base station and the first base station.

### Advantageous Effects

According to an exemplary embodiment of the present invention, one of the base stations which are dual-connected to the terminal may determine a type of a subframe to be used in the uplink and inform another base station and the terminal of the determined type, and the terminal may separately or simultaneously transmit the uplink signals or the channels based on the information on the type of subframe shared between the terminal and the at least two base stations. Further, the base stations may determine the priority on the basis of each base station, the channels, and the like based on the maximum transmission power, the power headroom, and the like for the uplink which are reported by the terminal and inform the terminal of the determined priority, thereby making the terminal effectively and simultaneously transmit the signals or the channels.

### DESCRIPTION OF THE DRAWINGS

FIG. 1 is a diagram schematically illustrating a wireless communication system for supporting dual connection according to an exemplary embodiment of the present invention.

FIG. 2 illustrates an SPS having a time interval of 10 ms.

FIG. 3 is a diagram illustrating a power allocation priority according to an exemplary embodiment of the present invention.

FIG. 4 is a diagram illustrating a correspondence relationship between a DL subframe and a UL subframe in a UL-DL configuration 3.

### MODE FOR INVENTION

In the following detailed description, only certain exemplary embodiments of the present invention have been shown and described, simply by way of illustration. As those skilled in the art would realize, the described exemplary embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a mobile station (MS) may be called a terminal, a mobile terminal (MT), an advanced mobile station (AMS), a high reliability mobile station (HR-MS), a subscriber station (SS), a portable subscriber station (PSS), an access terminal (AT), user equipment (UE), and the like, and may also include all or some of the functions of the MT, the MS, the AMS, the HR-MS, the SS, the PSS, the AT, the UE, and the like.

Further, the base station (BS) may be called an advanced base station (ABS), a high reliability base station (HR-BS), a node B (nodeB), an evolved node B (eNodeB), an access point (AP), a radio access station (RAS), a base transceiver station (BTS), a mobile multihop relay (MMR)-BS, a relay station (RS) serving as a base station, a relay node (RN) serving as a base station, an advanced relay station (ARS) serving as a base station, a high reliability relay station (HR-RS) serving as a base station, small base stations (a femto base station (femto BS), a home node B (HNB), a home eNodeB (HeNB), a pico base station (pico BS), a metro base station (metro BS), a micro base station (micro BS), and the like), a master eNB (MeNB), a secondary eNB (SeNB), and the like, and may also include all or some of the functions of the ABS, the nodeB, the eNodeB, the AP, the RAS, the BTS, the MMR-BS, the RS, the RN, the ARS, the HR-RS, the small base stations, and the like.

In addition, unless explicitly described to the contrary, the word “comprise” and variations such as “comprises” or “comprising” will be understood to imply the inclusion of stated elements but not the exclusion of any other elements. In addition, the terms “-er”, “-unit”, “-or”, and “module” described in the specification mean units for processing at least one function and operation, and can be implemented by software or hardware such as a microprocessor or components or a combinations of the software and the hardware.

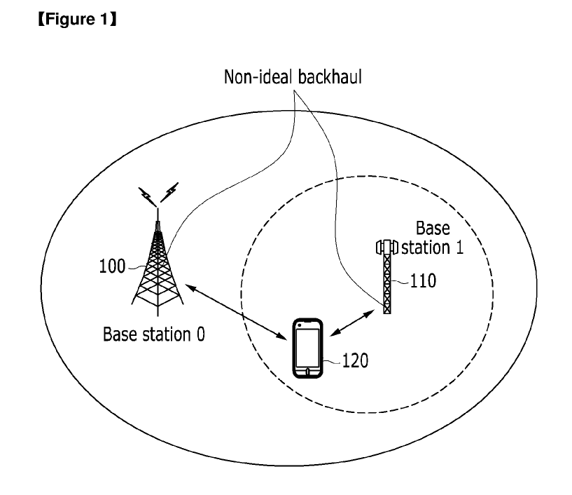

FIG. 1 is a diagram schematically illustrating a wireless communication system for supporting dual connection according to an exemplary embodiment of the present invention.

Referring to FIG. 1, a terminal 120 is connected to a base station 0 100 and a base station 1 110, and the base station 0 100 and the base station 1 110 are connected to each other through a non-ideal backhaul.

When the two base stations that are simultaneously connected to one terminal 120 are connected to each other through the non-ideal backhaul, each base station uses different resources for the terminal 120 to perform scheduling. In this case, the terminal 120 may transmit different types of uplink signals and channels to each base station. Since it is difficult for the two base stations to immediately exchange information through the non-ideal backhaul, an uplink-shared channel (UL-SCH) and uplink control information (UCI) which are transmitted by the terminal 120 need to be transmitted separately from each other when being targeting cells to which different base stations belong, thereby making each base station efficiently perform the scheduling.

Further, a transmission format of the UL-SCH and the UCI transmitted to each base station by the terminal 120 need to be determined by an operation of the corresponding base station and the terminal 120. The reason is that dynamic scheduling performed by each base station is not greatly limited, and each base station easily receives the UL-SCH and the UCI. Similarly, when the dynamic scheduling information is not immediately shared between the base stations, each base station needs to perform downlink transmission by using the mutually separated signals and channels for each base station. That is, a downlink-shared channel (DL-SCH) and downlink control information (DCI) are managed for each base station and need to be transmitted through the mutually separated signals and channels.

In the exemplary embodiment of the present invention, it is assumed that the two base stations are connected to one terminal 120 and that the separated transmission to each base station is performed. Hereinafter, the two base stations connected to the terminal 120 are called the base station 0 100 and the base station 1 110. Further, a set of serving cells which are managed by the base station 0 100 is called a cell group 0 and a set of serving cells which are managed by the base station 1 110 is called a cell group 1. Different carriers (or component carriers (CC)) may be used for the serving cells which are managed by each base station.

The terminal 120 may not simultaneously satisfy transmission powers required in the two base stations in response to the channel environment. For example, when the terminal 120 simultaneously transmits the signal or the channel to the two base stations, if power is preferentially allocated to a physical uplink shared channel (PUSCH) and a physical uplink control channel (PUCCH) of the cell group 0, the PUSCH and the PUCCH transmitted to the cell group 1 may not reach the required magnitude of power. In particular, a hybrid automatic repeat request (HARQ) is not applied to the transmission of the UCI and therefore a risk of loss is possible. In this case, when the loss occurs in the control information, transmission efficiency of the cell group 1 may be reduced. Therefore, in this case, there is a need to make adjustments of the UCI transmission between the cell groups so that the UCI transmission to the two base stations is not generated in the same subframe.

According to the exemplary embodiment of the present invention, the two base stations may each determine an available uplink subframe in advance so that a semi-static resource is not generated in the same subframe. In the case of the semi-static resource, the base station 0 100 may transmit configuration information of the resource to be used by the base station 0 100 to the base station 1 110, and the base station 1 110 may determine resources in a range in which the base station 1 110 does not collide with the base station 0 100.

Further, according to the exemplary embodiment of the present invention, the two base stations may determine a dynamic resource allocable subframe in advance so that the dynamic resource allocation does not overlap in the same subframe. In this case, the uplink resource may be dynamically allocated for an uplink HARQ-ACK transmitted as a response to a PDCCH/enhanced-PDCCH (e-PDCCH) which instructs the PUSCH (which may be allocated by the DCI), and the PDSCH or instructs a downlink semi-persistent scheduling (SPS) release, a trigger type 1 sounding reference signal (SRS), and the like.

To make the two base stations avoid allocating the PUSCH to the same subframe, each base station may determine the resource allocable subframe in advance using an uplink HARQ process (for example, in a response period to a request of the base station, the terminal 120 retransmits the signal or the channel) as a unit. When the two base stations use the subframes corresponding to different HARQ processes to allocate the PUSCH, the two base stations may not allocate the PUSCH to the same subframe. Further, the subframe to which the uplink HARQ-ACK transmitted as the response to the PDCCH/e-PDCCH instructing the PUSCH or the downlink SPS release is allocated may also be allocated as the uplink HARQ process unit. That is, to avoid the uplink resource from being be dynamically allocated to the same subframe, each base station may determine the subframe (dynamic resource allocable subframe) to which the dynamic resources may be allocated depending on the HARQ process. For example, when the base station 0 100 determines the dynamic resource allocable subframe and informs the base station 1 110 of the determined dynamic resource allocable subframe, the base station 1 110 may use the rest of the subframe other than the subframe determined by the base station 0 100 for the dynamic resource allocation.

That is, according to the exemplary embodiment of the present invention, to prevent the two base stations from allocating resources to the same subframe, the base station 0 100 of the two base stations determines the semi-static resource allocation configuration information and the dynamic resource allocable subframe, and informs the base station 1 110 of the determined semi-static resource allocation setting information and the dynamic resource allocable subframe, while the base station 1 110 may allocate resources by referring to the semi-static resource allocation setting information and the dynamic resource allocable subframe.

Meanwhile, when the terminal 120 allocates available resources to simultaneously transmit the signals to each base station, each base station shares the resource allocation information and performs the scheduling based on the opponent's shared information. In this case, according to the exemplary embodiment of the present invention, the base station 0 100 and the base station 1 110 may divide a type of subframes into three and may share type information of the subframes. The type information of subframes shared by each base station is as follows. 1. Base station 0 dedicated subframe (only the transmission from the terminal to the base station 0 is possible)

2. Base station 1 dedicated subframe (only the transmission from the terminal to the base station 1 is possible)

3. Shared subframe (simultaneous transmission to the base station 0 and the base station 1 is possible)

The terminal 120 does not permit the transmission to the ‘base station 1 110’ in the ‘base station 0 dedicated subframe’. To the contrary, the terminal 120 does not permit the transmission to the ‘base station 0 100’ in the ‘base station 1 dedicated subframe’. However, in the ‘shared subframe’, the transmission to one base station of the base station 0 100 and the base station 1 110 and the simultaneous transmission to the two base stations of the base station 0 100 and the base station 1 110 are permitted.

Each base station needs to understand the information on the type of subframes of the uplink as described above. The information on the type of subframes of the uplink is determined by the base station 0 100 and may be informed to the base station 1 110.

The terminal 120 may divide the serving cell of the terminal 120 into the cell group 0 and the cell group 1, and may perform the uplink transmission to the cells belonging to each cell group using the independent signal and channel. In this case, each cell group may include one or a plurality of cells

The terminal 120 receives the semi-static resource allocation information used by the cell group 0 and the semi-static resource allocation information used by the cell group 1 from the base station 0 100 and the base station 1 110, respectively. An example of the semi-statically allocated resource may include an SPS scheduling resource, a periodic channel state information (CSI) report resource, a trigger-type 0 sounding reference signal resource, a scheduling request (SR) resource, and the like. Further, the terminal 120 depends on the scheduling instructions of the serving cell of the terminal 120 in the case of the dynamic resource allocation. In this case, when the base station 0 100 and the base station 1 110 inform the terminal 120 of the dynamic resource allocable subframe of the cell group 0 or the cell group 1, the terminal 120 uses the information on the dynamic resource allocable subframe of the cell group, thereby effectively performing the transmission/reception (monitoring and the like of PDCCH/e-PDCCH).

Meanwhile, a HARQ retransmission resource for fundamental transmission (hereinafter referred to as ‘initial transmission’) in the SPS scheduling for the cell group 0 may be allocated as as much as a maximum possible number of retransmission. In this case, since it may not be immediately understood whether the terminal 120 performs the retransmission in the cell group 1, the subframe (retransmission generation possible subframe) to which the retransmission resource is allocated may not be used as a resource in the cell group 1. However, considering the fact that the retransmission resource is almost not allocated, a method which does not use the subframe to which the retransmission resource is allocated in the cell group 1 as a resource has a problem in that the resource may not be efficiently used. Therefore, according to the exemplary embodiment of the present invention, the cell group 1 applies the PUSCH scheduling to the retransmission generation possible subframe, and when the retransmission to the cell group 0 and the PUSCH resource of the cell group 1 use the same subframe, the terminal 120 may select at least one of the cell group 0 and the cell group 1 to perform the transmission.

First, according to the exemplary embodiment of the present invention, when the PUSCH resource of the cell group 1 uses the same subframe as the SPS retransmission PUSCH resource of the cell group 0, the terminal 120 disregards the PUSCH of the cell group 1 and performs the retransmission to the cell group 0 (method 1).

According to another exemplary embodiment of the present invention, when the PUSCH resource allocated by the cell group 1 completely or partially overlaps an SPS retransmission PUSCH resource block allocated for the cell group 0, the terminal 120 does not perform the transmission for the cell group 1 in the corresponding subframe but performs only the transmission to the cell group 0. When the subframe used by the PUSCH resource of the cell group 1 partially or completely overlaps the subframe used by the SPS retransmission PUSCH resource of the cell group 0, if the allocated resource blocks do not overlap each other, the terminal 120 preferentially allocates transmission power for retransmission to the cell group 0 and uses the remaining transmission power to perform the PUSCH transmission to the cell group 1 (method 2).

Meanwhile, the power allocation method of the terminal 120 is a method that is determined independent of whether the UCI is included in the PUSCH transmission. According to another exemplary embodiment of the present invention, to secure the successful reception of the UCI, the power allocation may be allocated with priority depending on whether the UCI is included in the PUSCH transmission. For example, when there are multiple channels using the same subframe, the terminal 120 may allocate the transmission power depending on the following priority.

Priority: PUCCH of cell group 0>PUSCH of cell group 0 in which UCI is included>PUCCH of cell group 1>PUSCH of cell group 1 in which UCI is included>PUSCH of cell group 0 in which UCI is not included>PUSCH of cell group 1 in which UCI is not included

Meanwhile, the trigger-type 0 SRS resource may be positioned at a last SC-FDMA symbol of the subframe. According to the exemplary embodiment of the present invention, when the trigger-type 0 SRS is transmitted in a specific subframe, the last symbol of the PUSCH of the subframe is not used for transmission, and as a PUCCH format 1/1a/1b and a PUCCH format 3, a shortened format is used. In this case, the cell group 1 needs to understand configuration information on a predetermined trigger-type 0 SRS resource for its own cell and configuration information on a predetermined trigger-type 0 SRS resource for a cell of the cell group 0.

When the terminal 120 performs the uplink separated transmission to the two base stations, the signals or the channels transmitted to the two base stations may be allocated to the same subframe. When the terminal 120 transmits the signals or the channels to the two base stations, if the wireless environment is sufficiently good and the transmission power has a margin, the signal or the channel may be transmitted through the same subframe. However, if the wireless environment is not good or the transmission power does not have a margin, it is preferable that the terminal 120 does not simultaneously transmit the signals or the channels to the two base stations through the same subframe.

Each base station may enable the terminal 120 to measure and report a path loss for each base station to determine whether the simultaneous transmission is performed. For example, the terminal 120 may report the channel environment and the power headroom (value calculated depending on whether the simultaneous transmission is performed) to each base station.

According to the existing LTE standard, power control processes for each serving cell are present. In this case, each base station serves to control the power of the cells which are managed by the base stations. According to the exemplary embodiment of the present invention, the power control process for the cell managed by the base station 0 100 and the power control process for the cell managed by the base station 1 110 may differ from each other. Further, the base station 0 100 and the base station 1 110 may independently perform the power control on each dedicated subframe according to a classification of the subframe.

When the terminal 120 may not satisfy the transmission power required in each base station, the terminal 120 may not perform the simultaneous transmission to each base station. Further, if the terminal 120 inhibits the simultaneous transmission to each base station, when the channels for each base station are allocated to the same subframe, only the channel for the base station having high priority may be transmitted and the channel for the base station having low priority may not be transmitted. However, according to the above method, even though the resource for the transmission is allocated, since the signal or the channel is not transmitted because the terminal 120 may not satisfy the required transmission power, the resource may be wasted.

Therefore, according to the exemplary embodiment of the present invention, when the channels for each base station are allocated to the same subframe, the transmission power may be differently allocated to each base station based on the predetermined priority. In this case, even though the terminal 120 performs the simultaneous transmission to each base station in the shared subframe, it may not understand whether the power control is applied to each base station. Therefore, when the terminal 120 performs the simultaneous transmission to the base station having high priority and the base station having low priority, it is hard for the base station having low priority and that does not understand whether the simultaneous transmission is performed to control the uplink power. Further, it is difficult for each base station to understand the magnitude of power used for the transmission to other base stations through the restricted backhaul environment, such that it is more difficult to perform the dynamic power control and multi-channel scheduling (MCS).

When the maximum transmission power which may be used by the terminal 120 is determined in advance and a sum of the maximum transmission power for each base station does not exceed the maximum transmission power which may be used by the terminal 120, each base station may determine the maximum power to be used at the time of transmitting the signal to each base station by the terminal 120 based on the measurement results, the power headroom, and the like that the terminal 120 reports,

However, when the terminal 120 performs the simultaneous transmission to the two base stations, if the sum of transmission power required for each base station exceeds maximum transmission power P_{CMAX, c} of the terminal 120, the terminal 120 allocates power to each base station depending on priority. Further, only when each base station understands the power use condition of the terminal 120 are the power control, the resource allocation, adaptive modulation and coding (AMC), and the like efficiently performed.

According to the exemplary embodiment of the present invention, the terminal 120 sets the P_{CMAX, c} to each serving cell which is managed by the base station 0 100 and the base station 1 110 and reports the P_{CMAX, c} and the power headroom to the base station 0 100 and the base station 1 110. In this case, it is assumed that the base station 0 100 and the base station 1 110 do not share the dynamic scheduling information in real time due to the non-ideal backhaul environment.

According to the existing invention, even though each base station receives a power headroom report (PHR) for the serving cell which is managed by other base stations, the meaning may not be accurately understood. Generally, since the priority of the base station 0 100 is high, the information required by the base station 1 110 is the power headroom after the terminal 120 transmits the PUCCH or the PUSCH to the base station 0 100. Since the base station 1 110 has low priority, the terminal 120 uses the power headroom in the transmission power for the base station 0 100 to simultaneously transmit the channels or the signals to the base station 1 110. However, in the case of the PUSCH transmission, the used power may be variable depending on the transmission format, the resource allocation, and a power control instruction word, and therefore it is difficult for the base station 1 110 to understand the power headroom. Even in the case of the PUCCH, since a fluctuation of power allocated depending on the transmission format is large, it is hard for the base station 1 110 to understand the power headroom.

According to the exemplary embodiment of the present invention, the terminal 120 may apply the following power control method to the shared subframe. The terminal 120 first sets maximum power quantity P_{MAX} to the base station having high priority, and then may determine a quantity obtained by subtracting the P_{MAX} from the maximum transmission power as power for the base station having low priority. For example, the maximum power quantity for at least one macrocell which is managed by the base station 0 100 may be set to be the P_{MAX}, and the maximum power quantity for at least one serving cell C which is managed by the base station 1 110 may be set to be P_{CMAX,c}−P_{MAX}.

Meanwhile, the PHR in the LTE Release 10 standard TS 36.213 is defined as two types, i.e., type 1 and type 2.

First, the type 1 is the PHR which may be applied to all the serving cells of the terminal 120, and the PHR belonging to the type 1 is called type 1-1, type 1-2, and type 1-3. Each power headroom (PH) is calculated for the serving cell c and subframe i. That is, P_{CMAX, c}(i) is the maximum transmission power of the terminal 120 when the subframe i is transmitted to the serving cell c.

The type 1-1 PHR is used when the terminal 120 transmits only the PUSCH to the serving cell c without the PUCCH in the subframe i. The type 1-1 depends on the following Equation 1.

PH_{type 1-1,c}(i)=P_{CMAX,c}(i)−(power requested to transmit PUSCH to serving cell c in subframe i) (Equation 1)

The type 1-2 PHR is used when the terminal 120 transmits both of the PUCCH and the PUSCH to the serving cell c in the subframe i. The type 1-2 depends on the follow Equation 2.

PH_{type1-2,c}(i)=\tilde{P}_{CMAX,c}(i)−(power requested to transmit PUSCH to serving cell c in subframe i) (Equation 2)

The type 1-3 PHR is used when the terminal 120 does not transmit the PUSCH to the serving cell c in the subframe i. The type 1-3 depends on the follow Equation 3.

PH_{type1-3,c}(i)=\tilde{P}_{CMAX,c}(i)−(power requested to transmit virtual PUSCH) (Equation 3)

The next type 2 is PHR which may be used when the terminal 120 simultaneously transmits the PUCCH and the PUSCH in the subframe i, and the PHR belonging to the type 2 is called type 2-1, type 2-2, type 2-3, and type 2-4. In this case, in the existing LTE standard, the PUCCH may be transmitted to only a primary cell, but to support the dual connectivity in the present invention, the terminal 120 may configure the PUCCH transmission cells for each base station.

The type 2-1 PHR is used when the terminal 120 transmits the PUCCH and the PUSCH to the serving cell c in the subframe i. The type 2-1 depends on the follow Equation 4.

PH_{type2-1,c}(i)=P_{CMAX,c}(i)−(power requested to transmit PUCCH to serving cell c in subframe i+power requested to transmit PUSCH to serving cell c in subframe i) (Equation 4)

The type 2-2 PHR is used when the terminal 120 transmits only the PUSCH to the serving cell c without the PUCCH in the subframe i. The type 2-2 depends on the follow Equation 5.

PH_{type2-3,c}(i)=P_{CMAX,c}(i)+(power requested to transmit PUSCH to serving cell c in subframe i+power requested to transmit virtual PUCCH) (Equation 5)

The type 2-3 PHR is used when the terminal 120 transmits only the PUCCH to the serving cell c without the PUSCH in the subframe i. The type 2-3 depends on the follow Equation 6.

PH_{type2-3,c}(i)=P_{CMAX,c}(i)−(power requested to transmit PUCCH to serving cell c in subframe i+power requested to transmit virtual PUSCH) (Equation 6)

The type 2-4 PHR is used when the PUCCH or the PUSCH transmitted to the serving cell c in the subframe i by the terminal 120 are not present. The type 2-4 depends on the follow Equation 7.

PH_{type2-4,c}(i)=\tilde{P}_{CMAX,c}(i)−(power requested to transmit virtual PUSCH to serving cell c in subframe i+power requested to transmit virtual PUCCH) (Equation 7)

In the existing LTE system, the terminal 120 reports the PHR to each serving cell or reports the P_{CMAX, c} and the PHR. However, according to the exemplary embodiment of the present invention, even though the base station 0 100 and the base station 1 110 connected through the non-ideal backhaul are each reported with the PHR, it may not be understood that each PHR corresponds to which type of the plurality of types. That is, since the base station 0 100 and the base station 1 110 may not understand the mutual scheduling conditions, even though the terminal 120 transmits the PHR to each base station, the type information of the transmitted PHR may not be understood. Therefore, according to the exemplary embodiment of the present invention, each base station needs to accurately determine the power use condition of the terminal 120 by transmitting additional information to each base station along with transmitting the PHR by the terminal 120.

First, the terminal 120 reports the P_{CMAX, c} and the PHR for the serving cell which are managed by the base station 1 110 to the base station 1 110, and additionally transmits the P_{CMAX, c}, the PHR, and the type information of the PHR of the serving cell which are managed by the base station 0 100. For example, when the PHR reported to the base station 1 110 by the terminal 120 is the type 1, the type information informing that the PHR corresponds to what type of the type 1-1, the type 1-2, and the type 1-3 may be additionally transmitted.

Similarly, the terminal 120 reports the P_{CMAX, c} and the PHR for the serving cell which are managed by the base station 0 100 to the base station 0 100, and additionally transmits the P_{CMAX, c}, the PHR, and the type information of the PHR of the serving cell which are managed by the base station 1 100. For example, when the PHR reported to the base station 0 100 by the terminal 120 is the type 2, the type information informing that the PHR corresponds to what type of the type 2-1, the type 2-2, the type 2-3, and the type 2-4 may be additionally transmitted.

According to the exemplary embodiment of the present invention, the resource allocated to the terminal 120 by the base station may be classified into the semi-statically allocated resource (semi-static allocation resource) and the dynamically allocated resource (dynamic allocation resource). The semi-static allocation resource is a resource periodically and persistently allocated for a predetermined time, and in the LTE system, a resource allocated through downlink semi-persistent scheduling (DL SPS), a resource allocated through uplink semi-persistent scheduling (UL SPS), a periodic CSI reporting resource, and a scheduling request (SR) resource may be semi-statically allocated. In this case, the periodic CSI reporting resource and the SR resource are allocated to the terminal 120 through RRC signaling, and the resource allocated through the SPS may be allocated to the terminal 120 through RRC signaling and DCI signaling.

Table 1 shows a resource allocation period which may be configured in a subframe unit in the semi-static resource allocation method according to the exemplary embodiment of the present invention.

TABLE 1

| | FDD | TDD |
|---|---|---|
| SPS scheduling | 10, 20, 32, 40, 64, 80, 128, | 10, 20, 30, 40, 60, 80, 130, |
| interval | 160, 320, 640 | 160, 320, 640 |
| Periodic CSI | 2, 5, 10, 20, 40, 80, 160, | 1, 5, 10, 20, 40, 80, 160 |
| reporting | 32, 64, 128 | |
| period | | |
| SR period | 1, 2, 5, 10, 20, 40, 80, | 1, 2, 5, 10, 20, 40, 80, |

Further, as the signal transmission used for the semi-static resource allocation, there is trigger-type 0 sound reference signal (SRS) transmission. An allocation period of a natural subframe of the terminal 120 and a natural subframe of the cell for the Trigger-type 0 SRS transmission is as shown in the following Table 2.

TABLE 2

| | FDD | TDD |
|---|---|---|
| Natural SRS subframe | 1, 2, 5, 10 | 2, 5, 10 |
| period of cell | | |
| Natural SRS subframe | 2, 5, 10, 20, 40, 80, 160, | 2, 5, 10, 20, 40, 80, |
| period of terminal | 320 | 160, 320 |

In addition, the uplink HARQ-ACK resource corresponding to the PDSCH depending on the downlink SPS is semi-statically allocated. That is, even in the uplink HARQ-ACK transmission corresponding to the PDSCH, the resource may be semi-statically allocated.

Further, the uplink HARQ-ACK resource corresponding to the PDCCH/E-PDCCH instructing the release of the downlink SPS and the uplink HARQ-ACK resource corresponding to the PDSCH instructed by the DCI included in the PDCCH/E-PDCCH are semi-statically allocated.

Meanwhile, as the signal transmission used for the dynamic resource allocation, there is trigger-type 1 SRS transmission. The dynamic resource allocation dynamically allocates a PUSCH resource allocated by using the downlink DCI, and resources for the uplink HARQ-ACK transmission and the Trigger-type 1 SRS transmission.

According to the existing LTE system standard, a time interval of the SPS is a subframe unit, in which one of 10, 20, 32, 40, 64, 80, 128, 160, 320, and 640 ms may be used. In this case, the time interval of the SPS means the interval of the subframe in which an initial transmission or a first transmission is generated in the HARQ. In this case, the period of the subframe for retransmission for the initial transmission is eight as the subframe unit based on the subframe in which the initial transmission is generated (in the case of FDD).

According to the exemplary embodiment of the present invention, when dedicated subframes of each base station are determined, the SPS may be applied to each base station or at least base station 0.

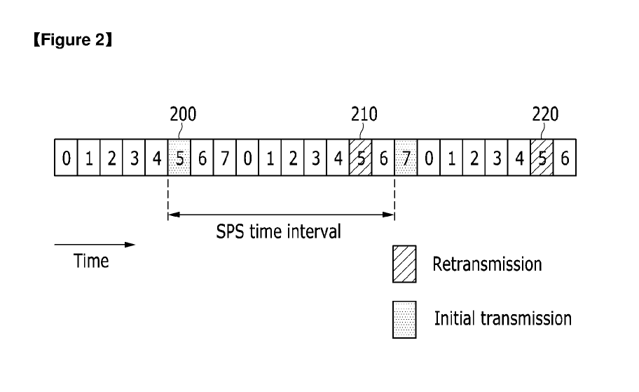

FIG. 2 illustrates an SPS having a time interval of 10 ms. In FIG. 2, the ‘time interval’ means the time interval of the initial transmission of the SPS, and is 10 ms. Referring to FIG. 2, first retransmission 210 of initial transmission 200 may be generated. In this case, the retransmission 210 may be first generated in the subframe after the initial transmission 200 by 8 ms, and then second retransmission 220 may be generated in a subframe after the first retransmission 210 by 8 ms.

According to the exemplary embodiment of the present invention, the time interval of the SPS which may be allocated in the subframe allocation for each base station may include 10, 20, 32, 40, 64, 80, 128, 160, 320, and 640 ms which are time intervals of the existing SPS. Even in the present invention, the time interval and a subframe offset of the SPS may be parameters determining the SPS allocation.

Meanwhile, similar to the SPS allocation, the subframe allocation and the SRS subframe allocation for the CSI reporting targeting each base station need to be available. In this case, code division multiplexing (CDM) for another terminal 120 may be applied to the CSI reporting and the SRS transmission, and therefore the terminal 120 according to the exemplary embodiment of the present invention which may be dual-connected to the base station may support the period of the existing LTE system.

According to the exemplary embodiment of the present invention, if the wireless environment of the terminal 120 is good for simultaneously transmitting the same subframe to the two base stations or does not have the transmission power to be able to perform the simultaneous transmission, the terminal 120 may not simultaneously perform transmission. In this case, the uplink resources allocated to different base stations are allocated to different subframes. For example, the base station may appropriately select and determine the subframe allocation period and the subframe offset so as to prevent the semi-static resources (SPS resource, SR resource, periodic CSI reporting, and the like) for each base station from being simultaneously generated in the same subframe. Further, the terminal 120 performs the power allocation and the uplink transmission depending on the predetermined priority when the uplink transmissions to each base station collide with each other in the same subframe.

According to the exemplary embodiment of the present invention, the base station may allocate resources to avoid the simultaneous transmission to the two base stations based on the wireless channel environment with the terminal 120. Further, according to the exemplary embodiment of the present invention, the base station determines an available subframe in consideration of the HARQ process at the time of the dynamic resource allocation. Further, the base station may allocate the semi-static allocation resources (SPS resource, SR resource, CSI reporting resource, SRS resource, and the like) in consideration of the HARQ process. For example, the base station may determine the semi-static allocation resource based on an integer multiple time of a round trip time (RTT) of the uplink HARQ process as a period. In this case, the uplink subframes transmitted to each base station may be set to not temporally overlap each other.

Meanwhile, even the SPS scheduling interval, the SR period, and the CSI reporting resource period which are determined in frequency division duplex (FDD) of Table 1 may additionally consider the integer multiple time of 8 ms of 8, 16, 24, and 32 subframes according to the period of the uplink HARQ process.

According to the exemplary embodiment of the present invention, the terminal 120 simultaneously transmits at least two signals or channels depending on the channel and signal associated with the simultaneous transmission and the priority information associated with the base station.

In this case, Table 3 shows the power allocation priority applied when the terminal 120 uses the same subframe to simultaneously transmit the signals or the channels to different base stations. Table 3 shows priority between UCI_0 and UL-SCH_0 transmitted to the base station 0 100 and between UCI_1 and UL-SCH_1 transmitted to the base station 1 110.

TABLE 3

| Base station 0 | Base station 1 (cell group 1) | |
|---|---|---|
| (cell group 0) | UCI_1 | UL-SCH_1 |
| UCI_0 | UCI_0 > UCI_1 | UCI_0 > UL-SCH_1 |
| UL-SCH_0 | UCI_1 > UL-SCH_0 | UL-SCH_0 > |
| | | UL-SCH_1 |

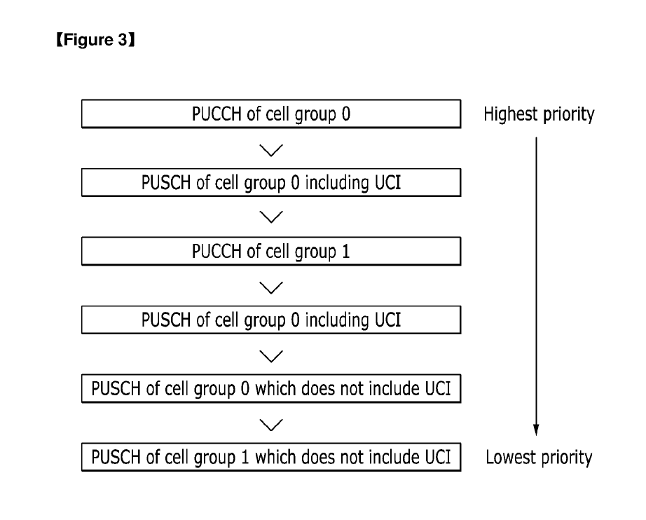

Referring to FIG. 3, when different types of information (UCI or UL_SCH) are allocated to the same subframe, the terminal 120 allocates higher priority to the UCI than to the UL-SCH, and when the same type of information is allocated to the same subframe, allocation depends on the above-determined priority. The UCI is control information and the HARQ is not applied, and therefore, to reduce a receiving failure, the UCI is allocated with higher priority than that of the UL-SCH to which data are transmitted. Further, in Table 3, the base station 0 100 has higher priority than that of the base station 1 110. The reason is that when the base station 0 100 is an MeNB and the base station 1 110 is a SeNB, the connection with the MeNB serving as the control plane needs to be more secured than the connection with the SeNB serving as the user plane. In the viewpoint of the terminal 120, the base station 0 100 corresponds to the cell group 0 of the two cell groups connected to the terminal 120, and the base station 1 110 corresponds to the cell group 1. Further, the terminal 120 preferentially allocates power to information having high priority and transmits information having low priority with power headroom.

FIG. 3 is a diagram illustrating power allocation priority according to an exemplary embodiment of the present invention.

Power allocation priority of Table 3 in the priority of FIG. 3 is added with a reference depending of a kind of channels (PUCCH or PUSCH).

For example, when the PUSCH for the base station 0 100 and the PUSCH for the base station 1 110 are allocated to the same subframe, the terminal 120 preferentially uses power for the PUSCH transmission (UCI_0 and UL-SCH_0) in the base station 0 (100) and uses power headroom for the PUSCH transmission (UL-SCH_1 or UCL_1 and UL-SCH_1) in the base station 1 110. Alternatively, when the PUCCH and the PUSCH for the base station 0 100 and the PUCCH and the PUSCH for the base station 1 110 are allocated to the same subframe, the terminal 120 most preferentially uses power for the PUCCH transmission of the cell group 0. In this case, the priority is PUCCH of cell group 0>PUCCH of cell group 1>PUSCH of cell group 0>PUSCH of cell group 1.

According to the exemplary embodiment of the present invention, since different carriers may be used for the serving cell managed by each base station, when the terminal 120 uses different carriers in the same subframe to simultaneously transmit the signal or the channel, an uplink data transmission rate of the terminal 120 may be maximized. In this case, the UCI of the terminal 120 is more important than the data transmission but is not applied with the HARQ unlike the data transmission, and therefore needs to secure reliability of transmission in only one-time transmission. Therefore, the priority of the UCI transmission may generally be set to be higher than that of the UL-SCH transmission. The priority between the UCIs may be changed depending on the kind of UCI. The UCI transmitted by the terminal 120 includes the uplink HARQ-ACK, the CSI reporting, and the SR. Among three kinds of UCIs, the uplink HARQ-ACK and the SR may have higher priority than that of the CSI reporting. When the same kind of UCIs collide with each other in the same subframe, the transmission priority of the UCI depends on the priority of the base station receiving the UCI.

Table 4 is a table showing the power allocation priority at the time of the collision of the PUCCH.

TABLE 4

| | Base station 0 | | |
|---|---|---|---|
| | CSI | | |
| Base station 1 | reporting_PUCCH_0 | HARQ-ACK_PUCCH_0 | SR_PUCCH_0 |
| CSI | CSI | HARQ-ACK_PUCCH_0 > | SR PUCCH_0 > |
| reporting_PUCCH_1 | reporting_PUCCH_0 > | CSI | CSI |
| | CSI | reporting_PUCCH_1 | reporting_PUCCH_1 |
| | reporting_PUCCH_1 | | |
| HARQ-ACK_PUCCH_1 | HARQ-ACK_PUCCH_1 > | HARQ-ACK_PUCCH_0 | SR_PUCCH_0 > |
| | CSI | > HARQ-ACK | HARQ-ACK_PUCCH_1 |
| | reporting_PUCCH_0 | PUCCH_1 | |
| SR_PUCCH_1 | SR_PUCCH_1 > | SR_PUCCH_1 > | SR_PUCCH_0 > |
| | CSI | HARQ-ACK_PUCCH_0 | SR_PUCCH_1 |
| | reporting_PUCCH_0 | | |

In Table 4, “HARQ-ACK_PUCCH_0>CSI reporting_PUCCH_1” means that the priority of the PUCCH including the HARQ-ACK transmitted to the base station 0 100 is higher than that of the PUCCH including the CSI transmitted to the base station 1 110.

According to the exemplary embodiment of the present invention, it is preferred that the collision of the SR transmission or the collision between the SR transmission and the HARQ-ACK transmission does not occur if possible, but in the case of the occurrence of collision, according to the Table 4, the SR transmission has priority over the transmission of the HARQ-ACK or the CSI reporting. When the HARQ-ACK is not normally transmitted to the base station, the base station may perform the retransmission to the terminal 120, but when the SR of the terminal 120 is not normally transmitted to the base station, the scheduling from the base station is delayed and thus a service delay may occur.

However, at the time of the collision between the SR transmission and the HARQ-ACK transmission, if the HARQ-ACK transmission is a response to the downlink SPS release, the terminal 120 may allocate higher priority to the HARQ-ACK transmission than the SR transmission. The reason is that when the response to the downlink SPS release is not normally transferred to the base station, the corresponding SPS resource may not be used, but even if the SR is not normally transmitted to the base station, the terminal 120 may transmit the SR to the base station through another subframe to which the SR resource is allocated.

According to the exemplary embodiment of the present invention, the priority means that power is preferentially allocated to a side having higher priority if the maximum transmission power of the terminal 120 is not sufficient when the two signals or channels are simultaneously transmitted. If all the available power of the terminal 120 is allocated to transmit the signal or the channel having higher priority, the power headroom is not present and therefore the signal or the channel having low priority may not be transmitted.

Meanwhile, when the system is designed to make the terminal 120 only transmit the SR to the base station 0 100, the SR transmission resource for the base station 1 110 is not allocated. If only the base station 0 100 allocates the SPS resource, the SPS release HARQ-ACK transmission to the base station 1 110 is not generated. Table 5 shows priority to resolve the collision between the PUCCH transmitted to the base station 0 110 and the PUCCH transmitted to the base station 1 110.

TABLE 5

| | Base station 0 | | |
|---|---|---|---|
| | CSI | | |
| Base station 1 | reporting_PUCCH_0 | HARQ-ACK_PUCCH_0 | SR_PUCCH_0 |
| CSI | CSI | HARQ-ACK_PUCCH_0 > | SR PUCCH_0 > |
| reporting_PUCCH_1 | reporting_PUCCH_0 > | CSI | CSI |
| | CSI | reporting PUCCH_1 | reporting_PUCCH_1 |
| | reporting_PUCCH_1 | | |
| HARQ-ACK_PUCCH_1 | HARQ-ACK_PUCCH_1 > | HARQ-ACK_PUCCH_0 > | SR_PUCCH_0 > |
| | CSI | HARQ-ACK PUCCH_1 | HARQ-ACK_PUCCH_1 |
| | reporting_PUCCH_0 | | |

According to another exemplary embodiment of the present invention, the terminal 120 in the dual transmission of the terminal 120 for the two base stations which is generated in the same subframe may abandon the transmission to any one of the base stations.

First, the case in which the SPS resource and the dynamic allocation resource collide with each other in the same subframe will be described.

According to the exemplary embodiment of the present invention, the base station may determine the uplink HARQ process and each base station may allocate a resource using the SPS. However, since the case in which the time interval of the initial transmission depending on the general SPS allocation is not the integer multiple of the RTT of the uplink HARQ process occurs, the collision therebetween may occur.

According to the exemplary embodiment of the present invention, it is hard for the dynamic scheduling information of each base station to be immediately exchanged between the two base stations due to the restrictive backhaul environment. Therefore, it is hard for the base station 0 100 to understand whether the SPS resource and the dynamically scheduled resource are included in the same subframe. On the other hand, the base station 1 110 receives the SPS allocation resource information from the base station 0 100 and therefore may understand the subframe, in which the SPS allocation resource of the base station 0 100 is included, in advance. That is, the base station 1 110 may not perform blind detection in the subframe in which the SPS resource allocated by the base station 0 100 is included.

Since the SPS allocation has semi-static characteristics, it is not easy to change the allocated resource. On the other hand, the dynamic scheduling performed for grant transmission has dynamic characteristics, and therefore the subframe may be freely changed. Therefore, the system may be designed so that the SPS allocation has higher priority than that of the dynamic resource allocation. When the terminal 120 is served by the two base stations (base station 0 100 and base station 1 110), the transmission form of the terminal 120 may be as follows.
The PUSCH transmission to the base station 0 100 by the uplink SPS resource allocation and the dynamic PUSCH transmission to the base station 1 110 (in this case, the PUSCH is allocated to the terminal 120 through the DCI). When the PUSCH for the base station 0 100 and the PUSCH for the base station 1 110 are included in the same subframe, the terminal 120 may transmit the PUSCH for the base station 0 100 in the corresponding uplink subframe and may not transmit the PUSCH to the base station 1 110.
When the uplink HARQ-ACK corresponding to the PDSCH transmitted from the base station depending on the downlink SPS resource allocation and the dynamic PUSCH transmission to the base station 1 110 are included in the same subframe, the terminal 120 transmits the HARQ-ACK to the base station 0 100 in the subframe and may not transmit the PUSCH for the base station 1 110.

Next, the case in which the SRS resource and the HARQ-ACK resource collide with each other in the same subframe will be described. When the PUCCH to which the HARQ-ACK for the base station 0 100 is transmitted and the SRS resource for the base station 1 110 are allocated to the same subframe, the terminal 120 uses the shortened format in the corresponding subframe to be able to transmit the PUCCH. When the SRS is transmitted in the subframe like the HARQ-ACK for another base station, the base station 1 110 needs to additionally perform an attempt to detect the SRS, and according to the exemplary embodiment of the present invention, each base station divides the signal transmitted in the shortened format, thereby securing the reliability of the signal reception.

Next, the case in which the CSI reporting the PUCCH resource and the HARQ-ACK PUCCH resource collide with each other in the same subframe will be described. When the HARQ-ACK PUCCH transmission for the base station 0 100 is dynamically generated and the periodic CSI reporting PUCCH resource for the base station 1 110 are allocated to the same subframe, the UCI for the two base stations are each separately transmitted and therefore the terminal 120 may not use the PUCCH format 2a/2b. Therefore, the terminal 120 may not transmit the CSI reporting PUCCH for the base station 1 110 and may transmit only the HARQ-ACK PUCCH for the base station 0 100. In this case, since the base station 1 110 may not recognize that only the HARQ-ACK PUCCH for the base station 0 110 is transmitted in the corresponding subframe, the blind detection for confirming whether the CSI reporting PUCCH is transmitted is performed or the CSI reporting PUCCH transmitted in the subframe which is likely to have a collision may be disregarded at all times.

Next, the case in which the SRS resource and the CSI reporting PUCCH resource collide with each other in the same subframe will be described. In this case, the terminal 120 determines the subframe which is likely to have a collision to abandon the SRS transmission in the corresponding subframe and transmit only the CSI reporting PUCCH. That is, the terminal 120 allocates priority to the CSI reporting PUCCH.

Next, the case in which the SPS resource and the HARQ-ACK PUCCH resource collide with each other in the same subframe will be described. In this case, the terminal 120 may abandon the SPS transmission or may abandon the HARQ-ACK transmission. When the terminal 120 abandons the SPS transmission, the terminal 120 determines all the subframes which are likely to have a collision so as to not increase the receiving complexity in the base station and abandons the SPS transmission in the corresponding subframes. Further, when the terminal 120 abandons the HARQ-ACK transmission, even though the uplink HARQ-ACK is dynamically generated, the terminal 120 does not transmit the HARQ-ACK in the corresponding subframe and transmits only the signal by the SPS.

Next, the case in which the SPS resource and the CSI reporting PUCCH resource collide with each other in the same subframe will be described. In this case, the terminal 120 may selectively transmit only one of the SPS resource and the CSI reporting PUCCH resource. This is to simply receive the signal in the base station, and the terminal 120 may abandon the SPS transmission or abandon the CSI reporting in all the subframes which are likely to have a collision.

Next, the case in which the PUSCH resource and the SRS resource collide with each other in the same subframe will be described. When the PUSCH resource for the base station 0 100 and the SRS resource transmitted to the base station 1 110 collide with each other in the same subframe, it is hard for the base station 1 110 to determine whether the SRS is transmitted and therefore may have a problem in reception. The reason is that the PUSCH resource is dynamically scheduled. According to the exemplary embodiment of the present invention, the terminal 120 may transmit the PUSCH to the base station 0 100 and may transmit the SRS to the base station 1 110 in the last symbol of the PUSCH. Alternatively, all the cells which are managed by the base station 0 100 and the base station 1 110 may use the same natural SRS subframe of the cell.

Next, the case in which the PUSCH resource and the SRS resource collide with each other in the same subframe will be described. According to the existing LTE standard, when the PUCCH and the SRS transmitted by the HARQ-ACK or the SR coincide with each other in the same subframe, if parameter ‘ackNackSRS-SimultaneousTransmission’ is ‘TRUE’, the terminal 120 transmits the PUCCH using the shortened format, and when parameter ‘ackNackSRS-SimultaneousTransmission’ is ‘FALSE’, the terminal 120 does not transmit the SRS. Further, when the PUCCH and the SRS transmitted by the HARQ-ACK and the SR using a general format are allocated to the same subframe, the terminal 120 does not transmit the SRS. However, it is hard for the base station 1 110 to determine whether the signal received in the corresponding subframe is the SRS, and therefore the terminal 120 according to the exemplary embodiment of the present invention uses a shortened format to transmit the PUCCH for the base station 0 100 at all times in the case of the collision of the subframe and uses the last SC-FDMA symbol of the corresponding subframe to transmit the SRS. Alternatively, to obtain the same effect by another method, all the serving cells of node 0 (cell group 0) and node 1 (cell group 1) may use the same configured natural SRS subframe of the cell.

Finally, when the SR resource and the HARQ-ACK PUCCH resource collide with each other in the same subframe, the terminal 120 may transmit one of the SR resource and the HARQ-ACK PUCCH resource depending on the priority.

According to another exemplary embodiment of the present invention, carrier aggregation (CA) of the TDD base station and the FDD base station in the restrictive backhaul environment will be described.

First, Table 6 shows the DL-UL correspondence relationship of a configuration of UL and DL of TDD-LTE (TS 36.211). In Table 6, ‘D’ is the downlink subframe, ‘U’ is the uplink subframe, and ‘S’ is a special subframe. The special subframe may be used for the downlink transmission.

TABLE 6

| Uplink- | Downlink- | | | | | | | | | | |
|---|---|---|---|---|---|---|---|---|---|---|---|
| downlink | to-Uplink | | | | | | | | | | |
| config- | Switch-point | Subframe number | | | | | | | | | |
| uration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

When the HARQ-ACK is transmitted in the specific uplink subframe, the DL-UL correspondence relationship is a relationship determining in which downlink subframe the PDSCH corresponding to the HARQ-ACK or the PDCCH instructing the downlink SPS release is generated.

Further, Table 7 shows the UL subframe to which ACK for the data received in the DL subframe of TDD-LTE is transmitted. In Table 7, the relationship between the DL subframe and the UL subframe may be determined depending on a downlink association set index (DASI).

TABLE 7

| UL-DL | | | | | | | | | | |
|---|---|---|---|---|---|---|---|---|---|---|
| Config- | Subframe n | | | | | | | | | |
| uration | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, | — | — | — | — | 8, 7, | — | — |
| | | | 4, 6 | | | | | 4, 6 | | |
| 3 | — | — | 7, 6, 11 | 6, 5 | 5, 4 | — | — | — | — | — |
| 4 | — | — | 12, 8, | 6, 5, | — | — | — | — | — | — |
| | | | 7, 11 | 4, 7 | | | | | | |
| 5 | — | — | 13, 12, 9, | — | — | — | — | — | — | — |
| | | | 8, 7, 5, | | | | | | | |
| | | | 4, 11, 6 | | | | | | | |
| 6 | — | — | 7 | 7 | 5 | — | — | 7 | 7 | — |

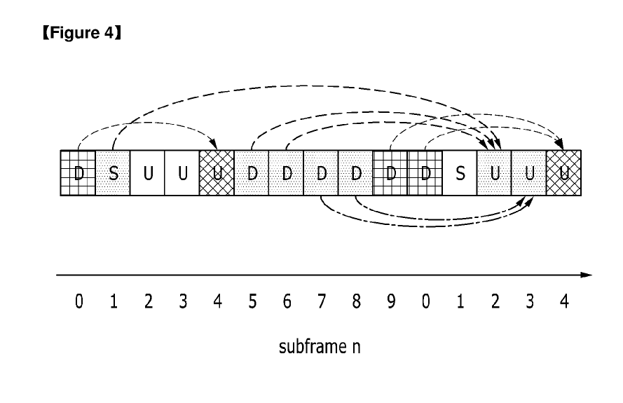

FIG. 4 is a diagram illustrating a correspondence relationship between a DL subframe and a UL subframe in a UL-DL configuration 3.

Referring to FIG. 4, the HARQ-ACK (corresponding to the PDCCH transmission instructing the PDSCH or the downlink SPS release) which is generated in UL subframes 1, 5, and 6 may be transmitted in subframe 2 of the subsequent wireless frame.

According to the exemplary embodiment of the present invention, the TDD carrier and the FDD carrier are used in the carrier aggregation (AC), and each carrier may be managed by different base stations. The two base stations are positioned away from each other geographically and are connected to each other through the non-ideal backhaul, such that the information exchange may be delayed and the exchange capacity may be limited.

The cell (TDD cell) of the base station using the TDD carrier and the cell (FDD cell) of the base station using the FDD carrier each use a separate UCI. According to the exemplary embodiment of the present invention, in the wireless communication system in which the dual connectivity is supported, the TDD cell is operated depending on the UL/DL reference configuration and the FDD cell may be operated like the existing FDD cell, but when the terminal 120 transmits the signals or the channels to the two cells, respectively, the simultaneous transmission problem may occur.

When the terminal 120 is in the channel environment in which it is hard for the UCI to be transmitted to the FDD cell and the TDD cell using the same subframe, the UCIs for each cell need not to be allocated to the same subframe. In the case of the TDD cell, the subframe which may transmit the UCI is restrictive, and therefore a UCI transmission possible candidate subframe of the TDD cell may be excluded from UCI transmission possible candidate subframes of the FDD cell. That is, the UCI transmission to the TDD cell may be preferentially considered.

The subframe to which the uplink HARQ-ACK transmitted as the response to the PDSCH or SPS release is transmitted may be determined by the UL/DL reference structure of the TDD. The downlink HARQ process is an asynchronous scheme, and therefore the TDD cell and the FDD cell differently determine the subframe to be used for the HARQ-ACK transmission.

Meanwhile, when both the FDD cell and the TDD cell perform the downlink SPS, each base station may avoid the HARQ-ACK (uplink HARQ-ACK transmitted as the response to the downlink SPS) resource collision of the FDD cell and the TDD cell based on the resource allocation interval and the offset configuration.

When the downlink SPS is applied to the FDD cell, if the PDSCH is allocated to subframe n, the uplink HARQ-ACK thereof may be allocated to subframe n+4. In the SPS having a period of 10 ms, one subframe may be used to transmit the uplink HARQ-ACK in one radio frame period. The TDD cell adjusts the PDSCH scheduling so that the HARQ-ACK is not transmitted in the subframe in which the HARQ-ACK transmitted from the FDD cell is included. Therefore, the base station of the TDD cell needs to understand the SPS configuration information used in the FDD cell.

In the dynamic resource allocation, to avoid the uplink HARQ-ACK collision, the subframe which may be used to transmit the uplink HARQ-ACK may be different in the TDD cell and the FDD cell.

According to the related art, to avoid the collision of the PUSCH resource in the FDD cell, different HARQ processes are used in each cell. In the wireless communication system in which the FDD cell and the TDD cell are mixed, the uplink HARQ process of the FDD cell is a synchronous scheme of RTT 8 ms and the uplink HARQ process of the TDD cell is a synchronous scheme of RTT 10 ms (TDD UL/DL configuration 1 to 5). Therefore, when the resource is allocated in the HARQ unit in each base station of the two cells, the case in which the PUSCH resource has a collision in the same subframe may essentially occur.

According to the exemplary embodiment of the present invention, the HARQ process used in the FDD cell and the TDD cell, respectively, may be determined, and the simultaneous transmission in the subframe in which the collision occurs may be performed. Therefore, the base station managing the FDD cell and the base station managing the TDD cell need to understand the HARQ process which is used by the FDD cell and the TDD cell. The terminal 120 performs the uplink transmission as scheduled in the FDD cell and the TDD cell, and the information on the HARQ process which is used by the FDD cell and the TDD cell is received from the base station to be able to efficiently perform the uplink transmission. The terminal 120 may differently allocate the transmission power to each cell depending on the priority in the subframe in which the simultaneous transmission is generated based on the information on the HARQ process or abandon the transmission of some of the signals or the channels.

As described above, according to an embodiment of the present invention, one of the base stations which are dual-connected to the terminal 120 may determine a type of subframe to be used in the uplink and inform another base station and the terminal 120 of the determined type, and the terminal 120 may separately or simultaneously transmit the uplink signals or the channels based on the information on the type of subframe shared between the terminal 120 and the at least two base stations. Further, the base stations may determine the priority on the basis of each base station, the channels, and the like based on the maximum transmission power, the power headroom, and the like for the uplink which are reported by the terminal 120 and inform the terminal 120 of the determined priority, thereby making the terminal 120 effectively and simultaneously transmit the signals or the channels.

Hereinabove, although the exemplary embodiments of the present invention have been described in detail, the scope of the present invention is not limited thereto, but modifications and alterations made by those skilled in the art using the basic concept of the present invention defined in the following claims fall within the scope of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. An uplink transmission method of a terminal in a wireless communication system which supports dual connection between the terminal and at least two base stations, the uplink transmission method comprising:
receiving first uplink scheduling information;
receiving second uplink scheduling information of a second base station from the second base station of the at least two base stations; and
transmitting uplink signals or channels to the first base station and the second base station, respectively, based on the first uplink scheduling information, and the second uplink scheduling information.

2. The uplink transmission method of claim 1, further comprising:
transmitting maximum transmission power and power headroom (PHR) for a serving cell managed by the first base station; and transmitting maximum transmission power, PHR, and type information of the PHR for a serving cell managed by the second base station to the first base station.

3. The uplink transmission method of claim 2, further comprising:
transmitting maximum transmission power and power headroom (PHR) for the serving cell managed by the second base station; and transmitting maximum transmission power, PHR, and type information of the PHR for the serving cell managed by the first base station to the second base station.

4. An uplink scheduling method of a base station in a wireless communication system which supports dual connection between a terminal and at least two base stations, the uplink scheduling method comprising:
allocating a semi-static resource to a first subframe;
transmitting information on the first subframe to a first base station of at least two base stations; and
transmitting uplink scheduling information including the information on the first subframe to the terminal.

5. The uplink scheduling method of claim 4, wherein
the semi-static resource
includes an SPS scheduling resource, a periodic channel state information (CSI) reporting resource, a trigger-type 0 resource, and a scheduling request (SR) resource.

6. The uplink scheduling method of claim 4, further comprising:
allocating a dynamic allocation resource to a second subframe;
transmitting information on the second subframe to the remaining one base station; and
transmitting uplink scheduling information including the information on the second subframe to the terminal.

7. The uplink scheduling method of claim 6, wherein
the dynamic allocation resource includes a resource for an uplink HARQ-ACK or a trigger-type 1 sounding reference signal (SRS) transmitted as a response to PDCCH/enhanced-PDCCH (e-PDCCH).

8. The uplink scheduling method of claim 6, wherein
the allocating the dynamic allocation to the second subframe includes
determining the second subframe in consideration of an uplink HARQ process.

9. An uplink scheduling method of a base station in a wireless communication system which supports dual connection between a terminal and at least two base stations, the uplink scheduling method comprising:
dividing a type of subframe into at least three types;
allocating an uplink resource to a first subframe of a first type of the at least three types; and
transmitting uplink scheduling information including information on the first subframe to the terminal.

10. The uplink scheduling method of claim 9, further comprising
transmitting information on the type of subframe to a first base station of the at least two base stations.

11. The uplink scheduling method of claim 10, wherein
the first subframe is a dedicated subframe of the base station, a second subframe of a second type of the at least three types is a dedicated subframe of the first base station, and a third subframe of a third type of the at least three types is a shared subframe of the base station and the first base station.

12. An uplink scheduling method of a base station in a wireless communication system which supports dual connection between a terminal and at least two base stations, the uplink scheduling method comprising:
receiving information on a first subframe to which an uplink resource of a first base station is allocated from the first base station of the at least two base stations;
allocating the uplink resource of the base station to the first subframe and another second subframe based on the information on the first subframe; and
transmitting uplink scheduling information including information on the second subframe to the terminal.

13. The uplink scheduling method of claim 12, further comprising
receiving information on a subframe divided into at least three types from the first base station.

14. The uplink scheduling method of claim 13, wherein
the first subframe of a first type of the at least three types is a dedicated subframe of the first base station, the second subframe of a second type of the at least three types is a dedicated subframe of the base station, and a third subframe of a third type of the at least three types is a shared subframe of the base station and the first base station.
